(19) United States
(12) Patent Application Publication
(10) Pub. No.: US 2019/0189026 A1
(43) Pub. Date: Jun. 20, 2019

(54) Systems and Methods for Automatically Integrating a Machine Learning Component to Improve a Spoken Language Skill of a Speaker

(71) Applicant: Blue Canoe Learning, Inc., Bellevue, WA (US)

(72) Inventors: Sarah Daniels, Bellevue, WA (US); Anthony D. Andrews, Bellevue, WA (US); Karen Ann Taylor, Takoma Park, MD (US); Laura McIndoo, Albuquerque, NM (US); Robin Barr, Takoma Park, MD (US); Tiffany Young, Salt Lake City, UT (US)

(73) Assignee: Blue Canoe Learning, Inc., Bellevue, WA (US)

(21) Appl. No.: 16/264,400

(22) Filed: Jan. 31, 2019

Related U.S. Application Data
(63) Continuation-in-part of application No. 16/017,762, filed on Jun. 25, 2018.
(60) Provisional application No. 62/642,481, filed on Mar. 13, 2018.
(60) Provisional application No. 62/524,562, filed on Jun. 25, 2017.

(51) Int. Cl. G09B 19/04; G09B 7/04; G06N 20/00; G10L 15/22; G10L 15/02; G10L 15/08

(52) U.S. Cl. CPC G09B 19/04; G09B 7/04; G06N 20/00; G10L 2015/088; G10L 15/02; G10L 15/08; G10L 2015/025; G10L 15/22

(57) ABSTRACT

Computer-implemented systems and methods for automatically integrating a machine learning component to improve a spoken language skill of a speaker. The method includes selecting an anchor phrase and a target word as part of an interactive game, presenting a visual representation of the anchor phrase and the target word to the speaker, processing a received and digitized anchor phrase and target word with a speech engine, extracting a plurality of features from speech engine output with a feature extraction device and transmitting the plurality of features to a plurality of classifiers, deriving a plurality of classifier outputs from the plurality of features with the feedback classifiers and transmitting the plurality of classifier outputs to a resolver, selecting a feedback response with the resolver using a set of pre-defined rules based at least in part on the plurality of classifier outputs, and presenting the feedback response to the speaker.

### CROSS-REFERENCE TO RELATED APPLICATION(S)

This application claims the benefit of U.S. Non-Provisional patent application Ser. No. 16/017,762, filed Jun. 25, 2018, U.S. Provisional Patent Application No. 62/642,481, filed Mar. 13, 2018, and U.S. Provisional Patent Application No. 62/524,562, filed Jun. 25, 2017, all incorporated herein by reference in their entireties.

### FIELD OF INVENTION

Systems and methods for automatically integrating a machine learning component to improve a spoken language skill of a speaker are disclosed, more specifically, a computer-implemented method for improving speaker pronunciation by presenting an anchor phrase and a target word as part of an interactive game and providing a feedback response to the speaker based at least in part on a plurality of features extracted from a speech engine output.

### BACKGROUND

Although English is an alphabetic language, it is not a phonetically written language, such that written English is not directly correlated with spoken English. This fact greatly complicates, and often inhibits, correct pronunciation by aspiring English speakers already fluent in another language or languages. Unlike Spanish, for example, where the letter “o” always represents the sound /o/ (as in rosa, flor, and jardinero), the letter “o” in English can represent a variety of sounds (as illustrated in the words “to,” “of,” “so,” “off,” “woman,” and “women”). The “deep orthography” of English sets it apart from other alphabetic languages, most of which have more transparent orthographies. Speakers of other languages often find it difficult to abandon their implicit assumption that “sounding it out” is an effective strategy for pronouncing the English words they see in print. Another challenge is that literate/native English speakers are successful readers precisely because they suppress awareness of deep orthography such that they, too, are prone to believe they are “sounding out” words even when those words feature ambiguous orthography (such as “snow” vs. “plow” and “clean” vs. “bread”). It should be noted that from successful readers come teachers of language and reading who, ironically, are sometimes predisposed to underestimate the problem of deep orthography with respect to learning. The conventional response to the problem of deep orthography in English is to represent pronunciation with phonetic symbols. Phonetic symbols are intended to establish a one-to-one correspondence between sound and symbol, thereby representing the way, a word sounds regardless of its spelling. Examples of American Phonetic Alphabet symbols used to indicate sounds in a word include: two /tuw/; son/sΛn/; go /gow/; off/ [symbol] f/; woman/w??m [symbol] n/; and women/w??m [symbol] n/.

Phonetic symbols provide linguists and other trained people with a common language to examine the sounds of language. However, phonetic symbols are limited in their accessibility, and are basically inaccessible to those who struggle with the printed word. Moreover, phonetic symbols appear in many forms, with the International Phonetic Alphabet and American Phonetic Alphabet serving as bases for the broad range of modified phonetic alphabets found in various English dictionaries. Faced with these multiple modified phonetic alphabets, struggling learners often learn to avoid dictionaries as a resource for determining the pronunciation of a word.

Presently, problems with existing pronunciation improvement methods often render those methods difficult to use and/or insufficiently effective in improving language pronunciation. It is desirable to mitigate or avoid these problems to more effectively improve language pronunciation.

### SUMMARY

As will be described in greater detail below, the instant disclosure describes various systems and methods for automatically integrating a machine learning component to improve a spoken language skill of a speaker.

In some embodiments, a computer-implemented method for automatically integrating a machine learning component to improve a spoken language skill of a speaker is disclosed. The method includes selecting an anchor phrase and a target word as part of an interactive game, wherein the anchor phrase has a plurality of words, wherein the anchor phrase and the target word both have an expected vowel sound of a stressed syllable in common, and wherein the expected vowel sound is part of an expected phoneme, presenting a visual representation of the anchor phrase and the target word to the speaker as part of the interactive game, receiving an audible anchor phrase and an audible target word from the speaker, converting the audible anchor phrase into a digital anchor phrase, converting the audible target word into a digital target word, processing the digital anchor phrase and digital target word with a speech engine to generate a speech engine output, wherein the speech engine output includes a phoneme transcript, and wherein the phoneme transcript includes the expected phoneme, extracting a plurality of features from the speech engine output with a feature extraction device and transmitting the plurality of features to a plurality of feedback classifiers, deriving a plurality of classifier outputs from the plurality of features with the feedback classifiers and transmitting the plurality of classifier outputs to a resolver, wherein at least one of the plurality of classifiers use the machine learning component, selecting a feedback response with the resolver using a set of pre-defined rules based at least in part on the plurality of classifier outputs, and presenting the feedback response to the speaker.

In some embodiments, a system for automatically integrating a machine learning component to improve a spoken language skill of a speaker is disclosed. The system includes at least one physical processor and a physical memory comprising computer-executable instructions that, when executed by the at least one physical processor, cause the at least one physical processor to select an anchor phrase and target word as part of an interactive game, wherein the anchor phrase has a plurality of words, wherein the anchor phrase and the target word both have an expected vowel sound of a stressed syllable in common, and wherein the expected vowel sound is part of an expected phoneme, present a visual representation the anchor phrase and the target word to the speaker as part of the interactive game, receive an audible anchor phrase and an audible target word from the speaker, convert the audible anchor phrase into a digital anchor phrase, convert the audible target word into a digital target word, process the digital anchor phrase and digital target word with a speech engine to generate a speech engine output, wherein the speech engine output includes a phoneme transcript, and wherein the phoneme transcript includes the expected phoneme, extract a plurality of features from the speech engine output with a feature extraction device and transmitting the plurality of features to a plurality of feedback classifiers, derive a plurality of classifier outputs from the plurality of features with the feedback classifiers and transmitting the plurality of classifier outputs to a resolver, wherein at least one of the plurality of classifiers use the machine learning component, select a feedback response with the resolver using a set of pre-defined rules based at least in part on the plurality of classifier outputs, and present the feedback response to the speaker.

In some embodiments, a non-transitory computer-readable medium is disclosed. The non-transitory computer-readable medium includes one or more computer-executable instructions that, when executed by at least one processor of a computing device, cause the computing device to select an anchor phrase and target word as part of an interactive game, wherein the anchor phrase has a plurality of words, wherein the anchor phrase and the target word both have an expected vowel sound of a stressed syllable in common, and wherein the expected vowel sound is part of an expected phoneme, present a visual representation the anchor phrase and the target word to the speaker as part of the interactive game, receive an audible anchor phrase and an audible target word from the speaker, convert the audible anchor phrase into a digital anchor phrase, convert the audible target word into a digital target word, process the digital anchor phrase and digital target word with a speech engine to generate a speech engine output, wherein the speech engine output includes a phoneme transcript, and wherein the phoneme transcript includes the expected phoneme, extract a plurality of features from the speech engine output with a feature extraction device and transmitting the plurality of features to a plurality of feedback classifiers, derive a plurality of classifier outputs from the plurality of features with the feedback classifiers and transmitting the plurality of classifier outputs to a resolver, wherein at least one of the plurality of classifiers use the machine learning component, select a feedback response with the resolver using a set of pre-defined rules based at least in part on the plurality of classifier outputs, and present the feedback response to the speaker.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

These general and specific aspects may be implemented using digital hardware, corresponding software or a combination of hardware and software. Other features will be apparent from the description, drawings and claims.

### DRAWINGS

The figures depict embodiments for purposes of illustration only. One skilled in the art will readily recognize from the following description that alternative embodiments of the structures illustrated herein may be employed without departing from the principles described herein, wherein:

FIG. 1 is a screenshot of an example user interface of a computer-implemented method for automatically integrating a machine learning component to improve a spoken language skill of a speaker capable of implementing one or more of the embodiments disclosed herein;

FIG. 2 is another screenshot of an example user interface of a computer-implemented method for automatically integrating a machine learning component to improve a spoken language skill of a speaker capable of implementing one or more of the embodiments disclosed herein;

FIG. 3 is yet another screenshot of an example user interface of a computer-implemented method for automatically integrating a machine learning component to improve a spoken language skill of a speaker capable of implementing one or more of the embodiments disclosed herein;

FIG. 4 is a further screenshot of an example user interface of a computer-implemented method for automatically integrating a machine learning component to improve a spoken language skill of a speaker capable of implementing one or more of the embodiments disclosed herein;

FIG. 5 is a still further screenshot of an example user interface of a computer-implemented method for automatically integrating a machine learning component to improve a spoken language skill of a speaker capable of implementing one or more of the embodiments disclosed herein;

FIG. 6 is a chart that depicts a pronunciation score illustrating a method for automatically integrating a machine learning component to improve a spoken language skill of a speaker capable of implementing one or more of the embodiments disclosed herein;

FIG. 7 is a block diagram of a portion of some embodiments of a system 700 that produces user feedback and user scoring based at least in part on an incoming set of speech data as an example computer-implemented method for automatically integrating a machine learning component to improve a spoken language skill of a speaker capable of implementing one or more of the embodiments disclosed herein;

FIG. 8 a block diagram of some embodiments of a system that produces user feedback that is provided by a feedback classifier and holistic scoring, based at least in part on an incoming set of speech data as an example computer-implemented method for automatically integrating a machine learning component to improve a spoken language skill of a speaker capable of implementing one or more of the embodiments disclosed herein;

FIG. 9 is a flowchart of an example computer-implemented method for automatically integrating a machine learning component to improve a spoken language skill of a speaker capable of implementing one or more of the embodiments disclosed herein;

FIG. 10 is a first table of pseudo-code of an example computer-implemented method for automatically integrating a machine learning component to improve a spoken language skill of a speaker capable of implementing one or more of the embodiments disclosed herein;

FIG. 11 is a second table of pseudo-code of an example computer-implemented method for automatically integrating a machine learning component to improve a spoken language skill of a speaker capable of implementing one or more of the embodiments disclosed herein;

FIG. 12 is a block diagram of an example computer-implemented method for automatically integrating a machine learning component to improve a spoken language skill of a speaker capable of implementing one or more of the embodiments disclosed herein.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION

The following description and drawings are illustrative and are not to be construed as limiting. Numerous specific details are described to provide a thorough understanding of the disclosure. However, in certain instances, well known or conventional details are not described in order to avoid obscuring the description.

Reference in this specification to “one embodiment,” “an embodiment,” “some embodiments,” or the like, means that a particular feature, structure, characteristic, advantage, or benefit described in connection with the embodiment is included in at least one disclosed embodiment, but may not be exhibited by other embodiments. The appearances of the phrase “In some embodiments” in various places in the specification are not necessarily all referring to the same embodiment, nor are separate or alternative embodiments mutually exclusive of other embodiments. Similarly, various requirements are described which may be requirements for some embodiments but not for other embodiments. The specification and drawings are to be regarded in an illustrative sense rather than a restrictive sense. Various modifications may be made thereto without departing from the scope as set forth in the claims.

The inventors have observed that most of the variation among phonetic alphabets is seen in the representation of vowel sounds. Similarly, the inventors have observed that improper stress applied to vowel sounds is often an important source of poor or improper pronunciation, but not the only possible source of source of poor or improper pronunciation. In some embodiments, systems and methods described herein employ a pronunciation system such as the Color Vowel® system incorporated into an interactive game that presents an anchor phrase and a target word to the speaker for pronunciation. Correspondingly, a speech engine receives and processes a digitized audible anchor phrase and a digitized target word received from the speaker and produces speech engine output from which a plurality of features are extracted, and a plurality of classifier outputs are then derived from the plurality of features. In some embodiments at least one of a plurality of classifiers that derive the plurality of classifier outputs use a machine learning component. A resolver automatically selects a feedback response using a set of pre-defined rules based at least in part on the plurality of classifier outputs and then presents the feedback response to the speaker to improve their pronunciation skills.

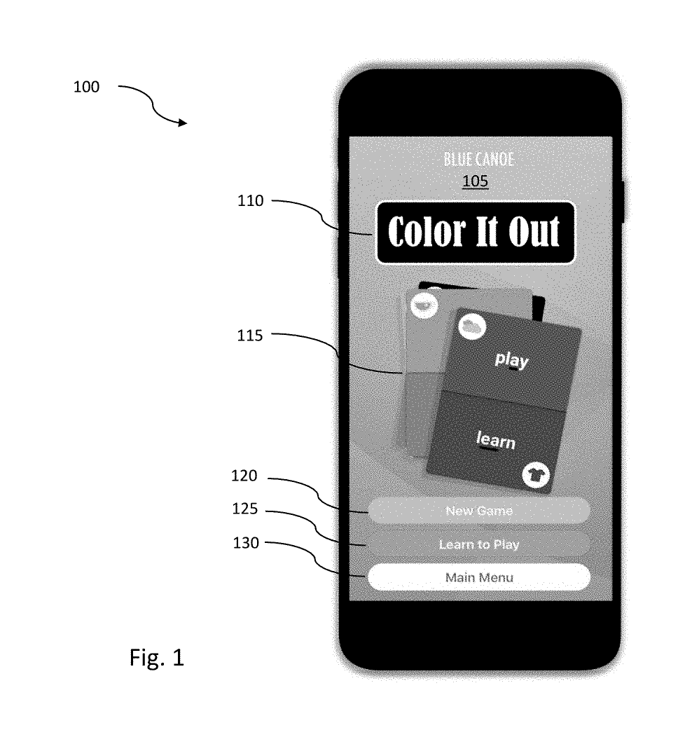

In FIG. 1, a screenshot of an example user interface 100 of a computer-implemented method for automatically integrating a machine learning component to improve a spoken language skill of a speaker capable of implementing one or more of the embodiments disclosed herein. In some embodiments, the user interface 100 is displayed by a communications device 105 displaying a name field 110 displaying a name of a game to a user, e.g. a speaker seeking to improve their pronunciation of English, wherein English is not their native or primary language. As used herein, without limitation, any “communications device” can be a desktop computer, mobile telephone, tablet, laptop or any compatible computing device such as Android® or iOS® mobile operating system supporting cellular telephone. In some embodiments, the name displayed in the name field 110 is “Color It Out,” corresponding to a Color Vowel® (“CV”) game employing the Color Vowel® system. In some embodiments, the user interface 100 includes a graphic illustration 115 representative of a CV game. In some embodiments, the graphic illustration 115 includes an image depicting a stack of CV cards, such as the CV cards described herein. In other embodiments, the graphic illustration 115 includes an image depicting a stack of CV cards, such as physical CV cards used in the Color Vowel® system including the Color Vowel® Chart from ELTS Solutions.

In some embodiments, the user interface 100 includes a new game button 120. In some embodiments, the user interface 100 detects activation of the new game button 120 by the user pressing a finger, or other compatible instrument, on a layer adjacent the new game button 120 displayed on the user's mobile device in a manner commonly known in the art to present the user with a displayed button. In some embodiments, the layer adjacent the new game button 120 is made of glass, for example, in an Apple® iPhone® and a Samsung® Galaxy® mobile telephone. However, the user's communications device 105 can be any type of type of communicating device capable of executing instructions and communicating directly or indirectly with a web server.

In some embodiments, the user interface 100 includes a user assistance button 125. In some embodiments, the user assistance button 125 is labelled “Learn to Play.” Activation of the user assistance button 125 causes the user interface 100 to display a description of the how to play the game and further provides examples to help a new user to become familiar with the functionality of the CV game. In some embodiments, the user interface 100 includes a main menu button 130. In some embodiments, the user assistance button 130 is labelled, “Main Menu.” Activation of the main menu button 130 causes the user interface 100 to display a number of selectable options including user-selectable game options and past performance results.

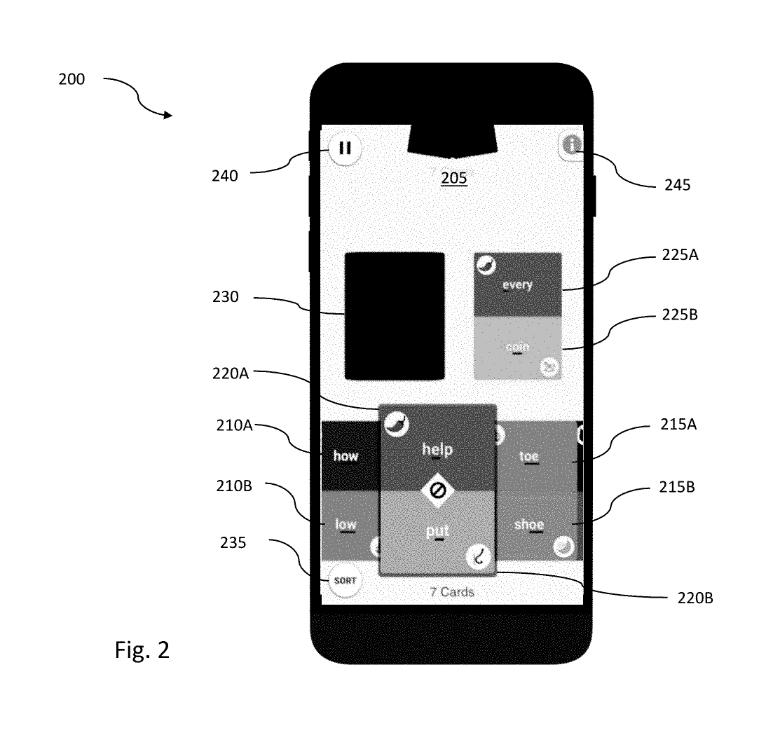

In FIG. 2, a screenshot of an example user interface 200 of a computer-implemented method for automatically integrating a machine learning component to improve a spoken language skill of a speaker capable of implementing one or more of the embodiments disclosed herein. Referring briefly to FIG. 1, when the new game button 120 is activated, in some embodiments, as shown in FIG. 2, it causes the user interface 200 to be displayed on the mobile device. In some embodiments, the user interface 200 is displayed by a communications device 205 that displays a portion of a series of seven (7) CV cards beginning with a first displayed CV card 210 and ending with a last displayed CV card 215, and includes a user-selectable CV card 220. Note that the series of seven CV cards 210-215, 220 used in the CV game is by way of example and any suitable number of CV cards may be used. The series of seven CV cards 210-215, 220 are initially selected from eight (8) available CV cards having eight different colors. In some embodiments, the number of available CV cards is increased from eight (8) to fourteen (14) as the user successfully interacts with the CV game, as described herein. The first displayed CV card 210 has a first displayed CV card top portion 210A and a first displayed CV card bottom portion 210B. Similarly, the last displayed CV card 215 has a first displayed CV card top portion 215A and a last displayed CV card bottom portion 215B. The user-selectable CV card 220 is shown between the first displayed CV card 210 and the last displayed CV card 215. In this fashion, three CV cards 210, 215, 220 of the series of seven CV cards 210-215, 220 are displayed to the user. Again, the number of displayed cards is not limited to three CV cards and any suitable number may be used. Similar to CV cards 210 and 215, user-selectable CV card 220 has a user-selectable CV card top portion 220A and a user-selectable CV card bottom portion 220B. The user-selectable CV card top portion 220A and bottom portion 220B are displayed according to the CV system. By way of example, as shown in FIG. 2, the user-selectable CV card top portion 220A displays a graphic representation of a “red pepper” CV anchor phrase and “help” target word. The vowel sound designed by the letter “e” in the “help” target word is underlined to emphasize that this is the vowel sound the user will be asked to pronounce correctly in accordance with a set of rules of the CV game, and which matches a vowel sound in anchor phrase, “red pepper.” In this example, the letter “e” in the “help” target word in CV card 220 is correctly pronounced as the letter “e” in the red pepper anchor phrase in the user-selectable CV card top portion 220A.

Similar to the user-selectable CV card top portion 220A, the user-selectable CV card bottom portion 220B contains a vowel sound designed by the letter “u” as shown underlined in the word, “put.” to emphasize that this is the vowel sound the user will be asked to pronounce correctly, and which matches a vowel sound in anchor phrase, “wooden hook.”

In some embodiments, a user using their thumb, or other appendage, or a compatible instrument, can scroll back and forth between the three displayed CV cards 210, 215, 220 of the series of seven CV cards 210-215, 220 such that any CV card can be selected by the user by activating through a more prolonged touch of the user-selectable CV card 220. When the user selects the user-selectable CV card 220, it is reproduced, in the correct size, as a target CV card 225 and the target CV card that was previously displayed in that location is relocated leftwards over a draw pile 230. In some embodiments, the draw pile 230 is displayed as a darkened graphic to indicate to the user that no match CV card 225 has been moved into this location. In some embodiments, if none of the CV cards 210-215, 220 available to the user match the target CV card 225, the user can elect to activate the draw pile 230 to receive at least one additional CV card to choose from. As part of the game, the user is required to locate and select a CV card 220 wherein at least one of the user-selectable CV card top portion 220A and the user-selectable CV card bottom portion 220B contain the same anchor phrase as the target word in target CV card 225. The target card 225 contains a target CV card top portion 225A and a target CV-card bottom portion 225B, only one of which actually contains the target word, in some embodiments. In this example, the target word is “every” and the vowel sound is designated by the underlined letter “e.” In some embodiments, once the user selects a matching color vowel anchor phrase, in this case “red pepper” and selects the user-selectable CV card 220 also displaying the “red pepper” anchor phrase, the target CV card 225 with target word “help” appears to be repositioned and displayed over the draw pile 230 and user-selectable CV card 220 is similarly repositioned to the location previously occupied by the target CV card. Thus, the target word “every” and the matching target word “help” are displayed together over the draw pile 230 and the target CV card 225, respectively. The user is asked to pronounce the anchor phrase and target word displayed over the draw pile 230 and the matching anchor phrase and target word displayed as the target CV card 225, i.e., “red pepper every, red pepper help.”

In some embodiments, the user interface 200 also includes a sort button 235 that moves all of the playable CV cards together (if any) on the left side of the displayed list of cards in a stack of CV cards on the first displayed CV card 210, and a CV card in the user-selectable CV card 220 position so that it can be easily selected by the user or another CV card from the first displayed CV card 210 moved to replace it as the user-selectable CV card 220.

For increased flexibility, the user can pause the CV game by activating the pause bottom 240. If the user would like further information about some aspect of the CV game, a help function can be initiated by the user activating the info button 245.

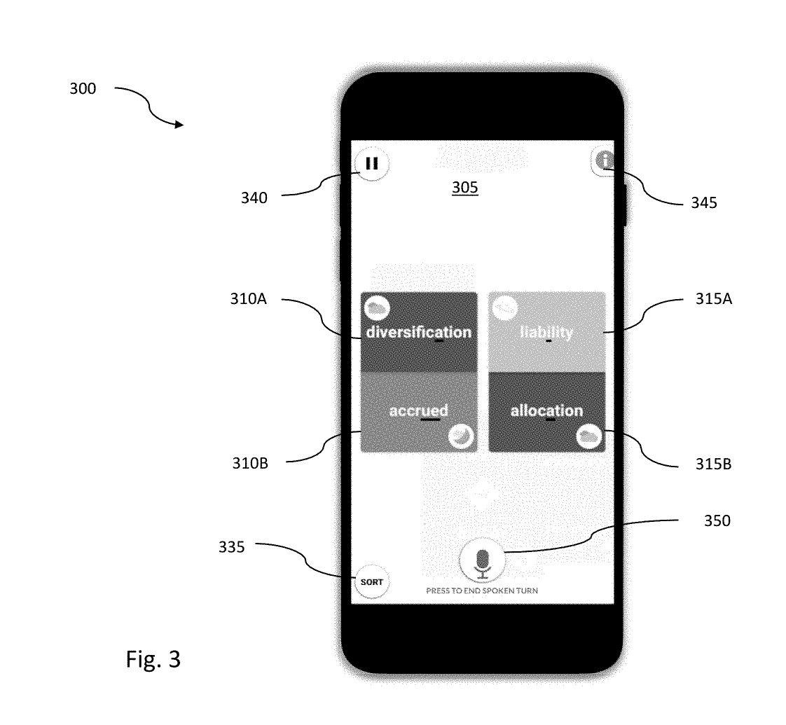

In FIG. 3, a screenshot of an example user interface 300 of a computer-implemented method for automatically integrating a machine learning component to improve a spoken language skill of a speaker capable of implementing one or more of the embodiments disclosed herein. Similar to the user interface 200 described above, the user interface 300 is displayed by a communications device 305 that displays a target CV card 310 and a user-selected target CV card 315. In this example, the target CV card 310 has a target CV card top portion 310A and a target CV card bottom portion 310B. Similarly, the user-selected target CV card 315 has a user-selected target CV card top portion 315A and a user-selected target CV card bottom portion 315B. In this example, the user chose the user-selected target CV card 315 because the user-selected target CV card bottom portion 315B uses the same anchor phrase that the target CV card top portion 310A, i.e., “gray day.” Thus, the user is asked to pronounce the anchor phrase and target word displayed in the target CV card top portion 310A and the matching anchor phrase and target word displayed as the user-selected target CV card bottom portion 315B, i.e., “gray day diversification, gray day allocation.” The vowel sound designed by the letter “a” in the “diversification” and “allocation” target words is underlined to emphasize that this is the vowel sound the user will be asked to pronounce correctly in accordance with the set of rules of the CV game, and which matches a vowel sound in the anchor phrase, “gray day.” The user activates a microphone icon 350 to signal that the user is about to attempt to pronounce the requested anchor phrase, first target word, requested anchor phrase and second target word, i.e., “gray day diversification, gray day allocation.” In some embodiments, the user deactivates the microphone icon 350 to indicate that the user has completed a pronunciation attempt, in other embodiments, the end of the attempt is recognized automatically by a speech engine described herein.

A sort button 335, a pause button 340 and an info button 345 correspond to and perform the functions of the sort button 235, pause button 240 and info button 245 from FIG. 2, to sort CV cards, pause the CV game and present information, respectively.

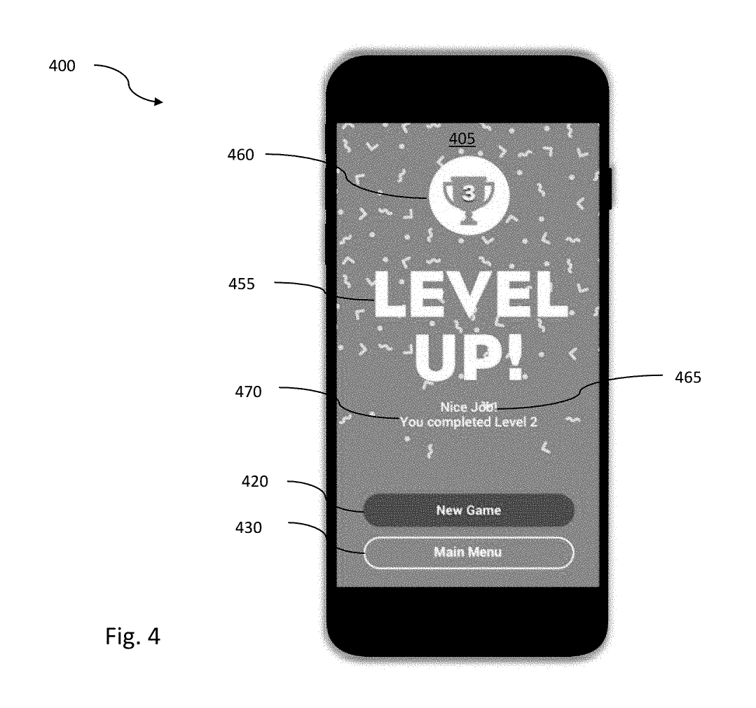

In FIG. 4, a screenshot of an example user interface 400 of a computer-implemented method for automatically integrating a machine learning component to improve a spoken language skill of a speaker capable of implementing one or more of the embodiments disclosed herein. The user interface 400 is displayed by a communications device 405 that displays a level status field 455. In this example, the level status field 455 displays, “LEVEL UP!” that visually confirms to the user a positive result of their previous interaction has resulted in their level being advanced in the CV game. In some embodiments, advancing a level corresponds to completion of a pre-determined number of games, e.g., one game. For example, without limitation, the series of seven CV cards 210-215, 220 (FIG. 2) available in the CV game to the user is selected from eight (8) of fourteen (14) different color CV cards in their first game. After successful completion of the first game, the game is advanced to the next level, i.e., “Level 2”. In game play at Level 2 and beyond, the number of CV cards the series of seven CV cards 210-215, 220 (FIG. 2) is selected from is increased, e.g., to all fourteen (14) different color cards. In other embodiments, advancing a level corresponds to a pre-determined improvement in pronunciation accuracy. In some embodiments, after successful completion of two or more games, the user is advanced to “Level 3” and special cards are added for selection by the user with play options such as “skip”, “take two” and “wild card.” These special cards add corresponding beneficial game play to the interactive game to enhance user interaction and foster greater user interest. In some embodiments, the message in the level status field 455 acts as a positive reinforcement for the user, implicitly encouraging the user to keep striving to improve their pronunciation because their efforts playing the CV game are productive. Above the level status field 455, the level achievement symbol 460 is displayed. In some embodiments, the level achievement symbol 460 is a depiction of a trophy silhouette with the number of a current level displayed therein. Below the level status field 455, a feedback phrase field 465 is displayed. In some embodiments, the feedback phrase field 465 displays, “Nice job!” Below the feedback phrase field 465, an accomplishment description field 470 is displayed. In some embodiments, the accomplishment description field 470 displays, “You completed Level 2.” A corresponding accomplishment description field 470 entry is employed for every level supported by the CV game. Similar to the new game button 120 and the main user button 130 shown in FIG. 1, the user interface 400 in FIG. 4 includes a new game button 420 and a main user button 430 that perform the same functions, respectively.

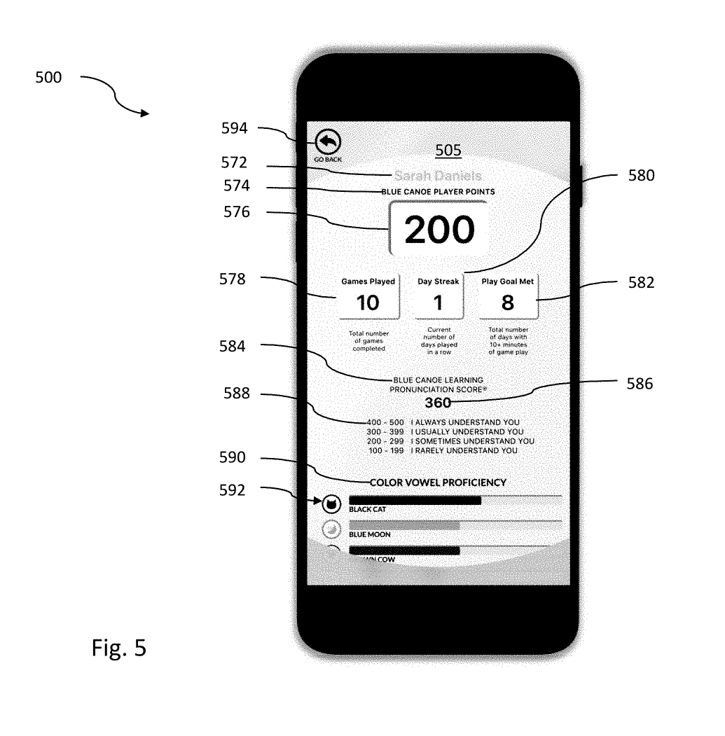

In FIG. 5, a screenshot of an example user interface 500 of a computer-implemented method for automatically integrating a machine learning component to improve a spoken language skill of a speaker capable of implementing one or more of the embodiments disclosed herein. The user interface 500 is displayed by a communications device 505 that displays a user name field 572. In some embodiments, the user name field 572 displays a name of the user, e.g., “Sarah Daniels.” Below the user name field 572 is a point description field 574. In some embodiments, the point description field 574 provides a corresponding description, e.g., “Blue Canoe Player Points.” Below the point description field 574 is a point field 576. In some embodiments, the point field 576 displays the number of points accumulated by the user, “200.” The point field 576 is not limited to any particular value and any point value from the CV game may be displayed. Below the point field 576 is a games played field 578, a day streak field 580 and a play goal met field 582, all positioned in a row for user convenience as shown in FIG. 5, although any positioning may be used. In some embodiments, the games played field 578 displays a total number of games played by the user, e.g., “10” with a corresponding description beneath. In some embodiments, the day streak field 580 displays a current number of days played in a row by the user, e.g., “1” with a corresponding description beneath. In some embodiments, the play goal met field 582 displays a total number days with 10+ minutes of game play, e.g., “8.” In the CV game, a play goal can be any goal supported by the game, e.g., each acceptable pronunciation.

The user interface 500 is displayed by the communications device 505 that displays a user score label field 584. In some embodiments, the user score label field 584 displays a description of the user score, e.g., “BLUE CANOE LEARNING PRONUNCIATION SCORE®”. Below the user score label field 584 is a user score field 586. In some embodiments, the user score field 586 displays the user's pronunciation score, e.g., “360.” Below the user score field 586 is a user score legend field 588. In some embodiments, the user score legend field 588 displays user score ranges and corresponding descriptions, e.g., “400-500 I ALWAYS_UNDERSTAND YOU”, “300-399 I USUALLY UNDERSTAND YOU”, “200-299 I SOMETIMES UNDERSTAND YOU”, and “100-199 I RARELY UNDERSTAND YOU”. Below the user score legend field 588 is a proficiency label field 590. In some embodiments, the proficiency label field 590 displays a label for user proficiency information, e.g., “COLOR VOWEL PROFICIENCY”. Below the proficiency label field 590 is a proficiency field 592. In some embodiments, the proficiency field 592 includes at least one measurement of user proficiency for an anchor phrase, e.g., “BLACK CAT” and a corresponding histogram, “BLUE MOON” and a corresponding histogram, “BROWN COW” and a corresponding histogram, “GRAY DAY” and a corresponding histogram, and “RED PEPPER” and a corresponding histogram. Because the number of measurements of user proficiency for each anchor phrase may exceed the available space, they can be scrolled by the user to enable the user to review them all. For example, in FIG. 5, only two complete and one partial measurements of user proficiency for anchor phrases are displayed. The user interface 500 also contains a go back button 594 that may be activated by the user to cause the communications device 505 to display the previous user interface screen.

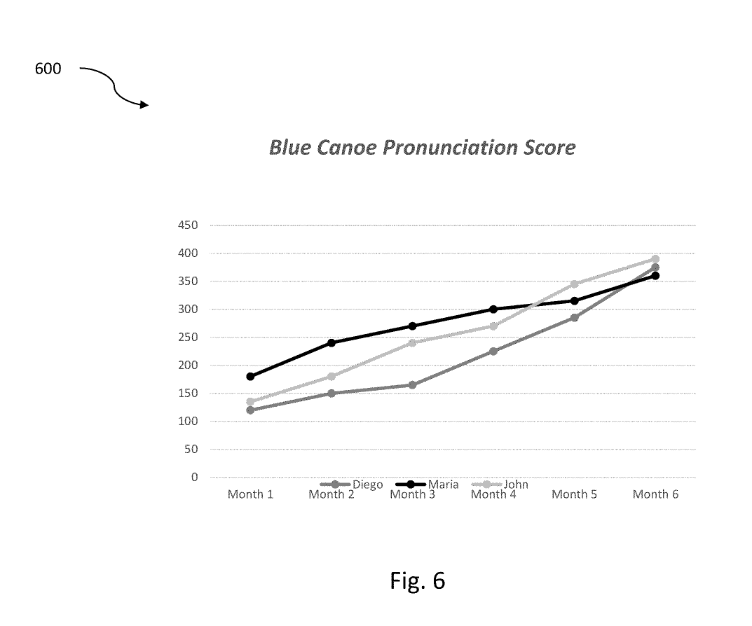

In FIG. 6, a chart 600 that depicts a pronunciation score illustrating a method for automatically integrating a machine learning component to improve a spoken language skill of a speaker capable of implementing one or more of the embodiments disclosed herein, is shown. The chart 600 depicts pronunciation scores on the y-axis on a scale from 0-450 versus integer increments of months on the x-axis on a scale from 0-6 months. The chart 600 depicts user pronunciation scores for a first user designated as, “Diego”, a second user designated as Maria and a third user designated as, “John”. In each of the three user pronunciation scores, the pronunciation score for each user increased over time regardless of where each user began at month zero (0). The chart 600 is based on actual user data and supports a clear advantage of the method for automatically integrating a machine learning component to improve a spoken language skill of a speaker described herein.

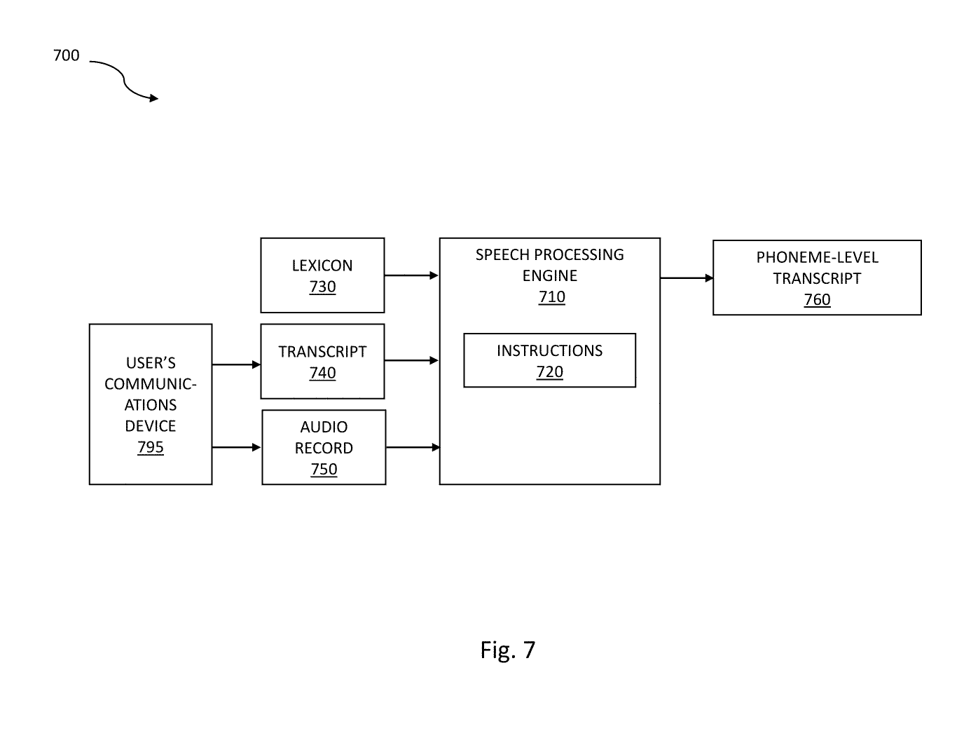

In FIG. 7, a block diagram of a portion of some embodiments of a system 700 that produces user feedback and user scoring based at least in part on an incoming set of speech data as an example computer-implemented method for automatically integrating a machine learning component to improve a spoken language skill of a speaker capable of implementing one or more of the embodiments disclosed herein, is shown. In some embodiments, the CV game referred to herein is being displayed to the user via a user's communication device 795. The user's communication device 795 contains a processor for executing instructions to perform the CV game and interact with the user as described herein. Interaction between the user and the CV game displayed by the user's communication device 795 correspondingly produce a transcript 740 and an audio record 750. The transcript 740 contains a record of all anchor phrases and targets words visually presented to the user and the resulting audible anchor phrase and audible target word (or words) as pronounced by the user and as interpreted by the user's communication device 795 into words. The audio record 750 is a digital audio recording of the auditory input received from the user including audible anchor phrases and an audible target words spoken by the user. A lexicon 730 of words used as part of the CV game is also produced. A speech processing engine 710 executes instructions 720 receive, process and interpret data from the lexicon 730, transcript 740 and audio record 750. The speech processing engine 710 processes and interprets audio waveforms to derive useful speech components such as vowels, consonants, phonemes, words, phrases and sentences. Importantly, the speech processing engine 710 detects useful speech components such as the detected words and their constituent phonemes and the time at which words and phonemes begin and end in the recording. In some embodiments, the speech processing engine 710 produces a speech processing engine output that includes a phoneme-level transcript 760. The phoneme-level transcript 760 includes detected phonemes and an analysis of vowel stress levels detected in the user's speech. In some embodiments, the phoneme-level transcript 760 contains a listing of all phoneme candidates and corresponding probability of matching an expected phoneme in the expected phrase. In some embodiments, the phoneme-level transcript 760 is at a phoneme level and includes, for each expected vowel phoneme, an estimate of the amount of stress applied to the vowel by the user. In some embodiments, the phoneme-level transcript 760 also indicates where expected phonemes were not present in the recorded audio, or where unexpected phonemes were detected in addition to the expected ones.

In some embodiments, examples of the speech processing engine 710 that produce speech engine output 805 including the phoneme transcript 760, include those described in: Speaker-Independent Phoneme Alignment Using Transition-Dependent States, by John-Paul Hosom (2009); and Automatic Phone Alignment, A Comparison between Speaker-Independent Models and Models Trained on the Corpus to Align, by Sandrine Brognaux, Sophie Roekhaut, Thomas Drugman and Richard Beaufort (2012), both attached in the Appendix and incorporated herein by reference in their entireties, and an open-source project (Gentle) that does alignment at the phoneme level based on a collaboration between Robert M Ochshorn and Max Hawkins (https://lowerquality.com/gentle/), incorporated herein by reference in its entirety.

In some embodiments, examples of speech engine 710 that produce speech engine output 805 including vowel stress measurement, include those described in: Detecting Stress in Spoken English using Decision Trees and Support Vector Machines, by Huayang Xie, Peter Andreae, Mengjie Zhang and Paul Warren (2004), in conjunction with, Learning Models for English Speech Recognition, by Huayang Xie, Peter Andreae, Mengjie Zhang and Paul Warren (2004); Lexical Stress Classification for Language Learning Using Spectral and Segmental Features, by Luciana Ferrer, Harry Bratt, Colleen Richey, Horacio Franco, Victor Abrash and Kristin Precoda (2014); and Lexical Stress Determination and its Application to Large Vocabulary Speech Recognition, by Ann Marie Aull and Victor W. Zue (1985), all attached in the Appendix and incorporated herein by reference in their entireties.

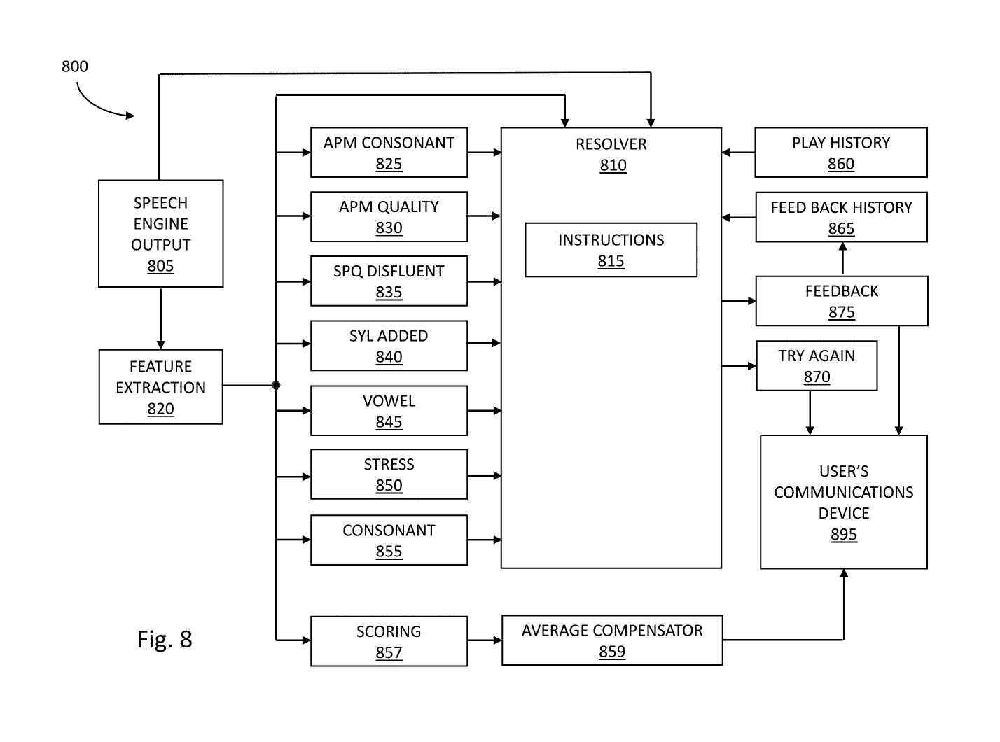

In FIG. 8, a block diagram of some embodiments of a system 800 that produces user feedback and user scoring based at least in part on an incoming set of speech data as an example computer-implemented method for automatically integrating a machine learning component to improve a spoken language skill of a speaker capable of implementing one or more of the embodiments disclosed herein, is shown. In some embodiments, a speech engine output 805 is the phoneme-level transcript 760 produced by the speech processing engine 710 in FIG. 7. In some embodiments, a speech engine output 805 includes the phoneme-level transcript 760 produced by the speech processing engine 710 in FIG. 7. In FIG. 8, the speech engine output 805 is transmitted to a resolver 810 containing a processor for executing instructions 815, and a feature extraction device 820. As described herein, the resolver 810 contains a set of pre-defined rules for processing data from the speech engine output 805, inter alia, derived from speech from the user during play of the CV game, and inputs from the CV game, to produce feedback to the user to improve a spoken language skill of the user. The speech engine output 805 is also processed by a feature extraction device 820. As used herein, “common features” are those features that are produced by the feature extraction device 820 that are transmitted to both feedback-type classifiers 825, 830, 835, 840, 845, 850, 855 and a holistic-type classifier 857. More specifically, the feedback-type classifiers are an anchor phrase mastery (APM) consonant classifier 825, an anchor phrase mastery (APM) quality classifier 830, a sound and play quality (SPQ) disfluent classifier 835, a syllables (SYL) added classifier 840, a vowel classifier 845, a stress classifier 850, and a consonant classifier 855. In some embodiments, the holistic-type classifier is an holistic scoring classifier 857. Classifier output is produced by each of the feedback-type classifiers 825, 830, 835, 840, 845, 850, 855 is transmitted to and processed by the resolver 810 as described herein. While “common features” are received by both the feedback-type classifiers 825, 830, 835, 840, 845, 850, 855 and the holistic-type classifier 857, “feedback features” are received by the feedback-type classifiers 825, 830, 835, 840, 845, 850, 855, but not the holistic-type classifier, and “scoring features” are received by the holistic scoring classifier 857, but not the feedback-type classifiers 825, 830, 835, 840, 845, 850, 855. In some embodiments, the resolver 810 receives common features, feedback features and holistic features.

In some embodiments, the feature extraction device 820 derives 159 different common features from the speech engine output 805 and transmits those features to the feedback-type classifiers 825, 830, 835, 840, 845, 850, 855 and the holistic scoring classifier 857, and directly to the resolver 810, as described herein. In some embodiments, the 159 common features from the feature extraction device 820 include individual variables for each feature corresponding to: A first expected phoneme of the detected word is “S” (1 variable). A number of expected phonemes (1 variable). An actual number of phonemes detected (1 variable). A number of detected phonemes judged to be incorrect (1 variable). A number of inserted phonemes divided by the actual number of phonemes detected (1 variable). A number of deleted (missing) phonemes divided by the actual number of phonemes detected (1 variable). An average aggregate confidence value for all detected phonemes (1 variable). An average number of candidate phonemes across all expected phonemes, only considering those where the candidate count for detected phonemes is non-zero (1 variable). An average aggregate confidence value for all phonemes judged to be correct (1 variable). An average aggregate confidence value for all phonemes judged to be incorrect (1 variable). An inserted number of vowels (1 variable). A maximum length of an inserted vowel in milliseconds (1 variable). A number of deleted (missing) vowels (1 variable). A number of inserted consonants (1 variable). A maximum length of an inserted consonant in milliseconds (1 variable). A number of deleted (missing) consonants (1 variable). A number of incorrect (substituted) consonants (1 variable). A number of consonant phonemes substituted with a vowel (1 variable).

In some embodiments, the 159 common features from the feature extraction device 820 further include a separate variable for each of the first four (4) weak consonants detected for: An expected phoneme for successive each “weak” consonant detected (4 variables). A number of candidate phonemes for each successive weak consonant detected (4 variables).

In some embodiments, the 159 common features from the feature extraction device 820 further include six (6) separate variables for each of the first four (4) weak consonants detected (24 total) for: A candidate phoneme for each successive sequential weak consonant detected (24 variables). A confidence score for each successive weak consonant detected (24 variables).

In some embodiments, the 159 common features from the feature extraction device 820 further include: An expected number of vowels in a target word (1 variable). An aggregate confidence value for the (expected) stressed vowel in the target word (1 variable). A name of the expected phoneme for the (expected) stressed vowel in the target word (1 variable). An estimated stress value (0-1000) for the (expected) stressed vowel in the target word (1 variable). A duration of the (expected) stressed vowel in the target word (1 variable). A “1” if the (expected) stressed vowel was judged to be correct, a “0” otherwise (1 variable). A “1” if the expected phoneme of the (expected) stressed vowel is among the top four (4) phoneme candidates, a “0” otherwise (1 variable). A number of candidate phonemes for the (expected) stressed vowel (1 variable).

In some embodiments, the 159 common features from the feature extraction device 820 further include a separate variable for each of the first four (4) detected candidate phonemes for the (expected) stressed vowel in the target word: A name of each successive candidate phoneme for the (expected) stressed vowel (4 variables). An aggregate confidence value of each successive candidate phone for the (expected) stressed vowel (4 variables).

In some embodiments, the 159 common features from the feature extraction device 820 further include: A number of vowels in the target word whose expected stress is either “secondary” or “unstressed” (1 variable).

In some embodiments, the 159 common features from the feature extraction device 820 further include a separate variable for each of the first four (4) detected unstressed vowels in the target word for: A name of the expected phoneme for each successive unstressed vowel in the target word (4 variables). A stress score for each successive unstressed vowel in the target word (4 variables). A duration of each successive unstressed vowel in the target word in milliseconds (4 variables). A number of candidate phones for each successive unstressed vowel in the target word (4 variables).

In some embodiments, the 159 common features from the feature extraction device 820 further include six separate variables for each of the first four (4) unstressed vowels in the target word and the first six phoneme candidates detected for each unstressed vowel detected (24 total) for: A candidate phoneme for each successive unstressed vowel detected (24 variables). A confidence score for each successive unstressed vowel detected (24 variables).

In some embodiments, the 159 common features from the feature extraction device 820 further include separate variables for: An expected number of vowels in the target word with secondary stress (1 variable). An expected number of vowels in the target word with no stress (1 variable). A sum of the estimated stress scores for all vowels with (expected) secondary stress divided by the number of expected secondary stress vowels multiplied by the estimated stress of the (expected) stressed vowel (1 variable). A sum of the estimated stress scores for all vowels with no expected stress divided by the number of expected unstressed (1 variable).

In some embodiments, each of the 159 common features from the feature extraction device 820 are received by the resolver 810, feedback classifiers 825-855, and the holistic scoring classifier 857, as described herein. The classifiers receive the features described herein, including features extracted from a user recording that may include an audible anchor phrase that is converted into a digital anchor phrase and an audible target word that is converted into a digital target word.

In some embodiments, the feature extraction device 820 derives 46 different feedback features from the speech engine output 805 and transmits those features to the feedback-type classifiers 825, 830, 835, 840, 845, 850, 855, but not the holistic-type classifier 857, and directly to the resolver 810, as described herein. In some embodiments, the 46 feedback features from the feature extraction device 820 include separate variables for each feature corresponding to: A minimum total anchor phrase confidence reported by the speech engine output 805 across both CV phrases (1 variable). A maximum total anchor phrase confidence reported by the speech engine output 805 across both CV phrases (1 variable). A number of consecutive phoneme deletions occurring at an end of an utterance (1 variable). A number of inserted phonemes beyond an expected end of the utterance (1 variable). A total number of deleted phonemes in received anchor phrases (1 variable). A total number of inserted phonemes in received anchor phrases (1 variable). A number of inserted phonemes prior to the expected utterance (1 variable).

In some embodiments, the 46 feedback features from the feature extraction device 820 further include separate variables for both of the anchor phrases corresponding to: A name of the phoneme detected consistently in the stressed vowel of the anchor phrase (or blank in the case of inconsistency (2 variables). A “1” if there was no consistency in the stressed vowels of the anchor phrase, or if the vowels were consistently wrong, a “0” otherwise (2 variables). A confidence score of the top stressed vowel candidate looking across all of the stressed vowels of the anchor phrase (2 variables). A confidence score of the second-scoring stressed vowel candidate looking across all of the stressed vowels of the anchor phrase (2 variables). A number of consonant insertions detected in the anchor phrase (2 variables). A number of consonant deletions detected in the anchor phrase (2 variables). A number of consonant substitutions detected in the anchor phrase (2 variables).

In some embodiments, the 46 feedback features from the feature extraction device 820 further include a separate variable for an aggregate number of errors in the anchor phrase reported in the speech engine output 805 (1 variable).

In some embodiments, the 46 feedback features from the feature extraction device 820 further include separate variables for three longest consonant insertions and their top two candidate phonemes across both anchor phrases corresponding to: A length of the three longest consonant insertions in the anchor phrases (3 variables). The top two candidate phones for the three longest consonant insertions in the anchor phrases (6 variables). The confidence value of the top two candidates for the three longest consonant insertions in the anchor phrases (6 variables). A name of a first deleted phoneme in the anchor phrases (or blank if no deletions) (1 variables). A name of a second deleted phoneme in the anchor phrases (or blank if no deletions) (1 variables). A name of the third deleted phoneme in the anchor phrases (or blank if no deletions) (1 variables).

In some embodiments, the 46 feedback features from the feature extraction device 820 further include separate variables for the three longest consonant substitutions and their top two phoneme candidates corresponding to: A length of the longest consonant substitution across all anchor phrases (3 variables). A name of the top two phonemes candidate in the three longest consonant substitutions across all anchor phrases (6 variables). A confidence score of the top two phone candidates in the three longest consonant substitutions across all anchor phrases (6 variables).

In some embodiments, the 46 feedback features from the feature extraction device 820 further include separate variables for both anchor phrases corresponding to: A number of deleted phonemes in the first anchor phrase divided by the total number of phonemes in the anchor phrase (2 variables). A number of deleted phonemes in the target word of the first CV pattern divided by the total number of phonemes in the target word (2 variables).

In some embodiments, the feature extraction device 820 derives 140 different scoring features from the speech engine output 805 and transmits those features to the holistic-type classifier 857, but not the feedback-type classifiers 825, 830, 835, 840, 845, 850, 855, and directly to the resolver 810, as described herein. In some embodiments, 140 different holistic features from the feature extraction device 820 include separate variables for a first 5 expected phonemes in a target word and first 6 candidate phonemes for each one corresponding to: A name of the expected phoneme in a target word (5 variables). A number of candidate phonemes for the expected phoneme in the target word (5 variables). A name of a candidate phoneme for the expected phoneme in the target word (30 variables). A confidence score for the candidate phoneme for the expected phoneme in the target word (30 variables).

In some embodiments, the feature extraction device 820 derives 140 different scoring features from the speech engine output 805 and transmits those features to the holistic-type classifier 857, but not the feedback-type classifiers 825, 830, 835, 840, 845, 850, 855, and directly to the resolver 810, as described herein. In some embodiments, 140 different holistic features from the feature extraction device 820 include separate variables for a last 5 expected phonemes in a target word and first 6 candidate phonemes for each one corresponding to: A name of the expected phoneme in a target word (5 variables). A number of candidate phonemes for the expected phoneme in the target word (5 variables). A name of a candidate phoneme for the expected phoneme in the target word (30 variables). A confidence score for the candidate phoneme for the expected phoneme in the target word (30 variables).

In some embodiments, the feedback-type classifiers 825, 830, 835, 840, 845, 850, 855 use machine learning to produce classifier output transmitted to the resolver 810. The holistic scoring classifier 857, also uses machine learning to produce output sent to an average compensator 859. In some embodiments, each classifier 825, 830, 835, 840, 845, 850, 855, 857 has a machine learning component that is a random forest classifier that has been trained using at least several thousand labeled recordings such that each random forest classifier learns to recognize the features sought in each classifier 825, 830, 835, 840, 845, 850, 855, 857.

The anchor phrase mastery (APM) consonant classifier 825 classifies if at least one problem is detected with consonants in an anchor phrase in the user recording.

The anchor phrase mastery (APM) quality classifier 830 is focused on the user's ability to speak the CV anchor phrase correctly and takes into account anchor phrase problems with a detected CV, color, consistency, and stressed vowel quality. In some embodiments, color problem with the detected CV is the user is consistently using the wrong vowel color for the stressed syllable in the anchor phrase, e.g. “seelver peen” instead of “silver pin”. A consistency problem is indicated if the user is sometimes using the wrong vowel color for the stressed syllable. A quality problem is indicated if the stressed vowel sound (in the anchor phrase) is near the intended vowel sound but the vowel quality is poor.

The sound and play quality (SPQ) disfluent classifier 835 classifies whether the recording is disfluent. In some embodiments, the recording is deemed disfluent if the recording in which speech was detected does not appear to follow the expected transcript. For example, disfluent speech occurs if the user is only speaking the target words without the anchor phrases, e.g. “see, three”. In another example, disfluent speech occurs if speech from other nearby speakers is received.

The syllables (SYL) added classifier 840 classifies syllables added and removed from the user recording. In some embodiments, the syllables (SYL) added classifier 840 classifies whether the user added as syllable to the target word in the recording and whether the user removed (omitted) a syllable from the target word in the recording.

The vowel classifier 845 classifies problems with the amount of stress on an unstressed vowel in the target word of the recording, such as over-stressed and color. The vowel classifier is also responsible for detecting quality problems in the stressed vowel sound. In some embodiments, over-stressed vowels are stressed too much, and stress should be reduced. For example, one over-stressed vowel should sound more like “schwa” (uh). For example, in “banana”, the “a” sound of the first and third syllable is reduced compared to the second (stressed) syllable. In some embodiments, a color problem is indicated where a user spoke the wrong CV for the stressed vowel in the target word.

The stress classifier 850 classifies problems with the stressed vowel in the target word such as unstressed syllables, under-stress syllables and improper stressed syllable location. In some embodiments, the unstressed syllables are indicated where the user spoke the target word with no significant stress on any syllable in the recording. In some embodiments, under-stress syllables are indicated in single-syllable words where the user under-stressed or omitted a vowel sound in the target word in the recording. In some embodiments, improper stressed syllable location is indicated where the user placed stress on the wrong syllable in the target word in the recording.

The consonant classifier 855 classifies problems with consonants such as missing and substituted consonants in the target word in the recording. In some embodiments, the missing (omitted) consonant problem is indicated where a consonant is missing from the target word. In some embodiments, the substituted consonant problem is indicated where an incorrect consonant is substituted for an expected consonant in the target word.

The resolver 810 also receives data from a play history device 860 and a feedback history device 865. The play history device 860 receives, stores and transmits a record of recent CV game play for each user. Correspondingly, the feedback history device 865 receives, stores and transmits a record of feedback provided to the user during each CV game. For example, the resolver 810 contains a set of pre-defined rules that determines to whether or not to activate the try again feature 870 and select feedback from a feedback device 875 to be transmitted to the user via a user's communications device 895 based in part on a play history received from the play history device 860 and a feedback history received from a feedback history device 865. In some embodiments, the set of pre-defined rules of the resolver 810 limits the number of identical requests to the user to try again in order to reduce user frustration. The set of pre-defined rules of the resolver 810, based in part on a play history received from the play history device 860 and a feedback history received from a feedback history device 865, determines that the user has fixed a previous problem reported to the user and provides positive feedback such as “Good job!” This positive feedback may occur even if the resolver 810 identified other problems with the recording.

In some embodiments, the resolver receives and uses data from the speech engine output 805, the feature extraction device 820, the classifiers 825-855, the play history device and the feedback history device to determine the proper output including output from the feedback device 875 and the try again feature 870 to be sent to the user's communications device 895 for display to the user. In some embodiments, the resolver 810 employs a set a set of hard-coded rules and thresholds to determine the correct output as described herein. The set of predefined rules of the resolver 810 is able to detect trends and patterns for each particular user and adjust its output accordingly. For example, the resolver 810 can place limits on the number of times a user will be asked to retry a given turn in the CV game. Basic audio properties, e.g., a number of clipped frames, minimum frame energy, and raw speech engine output also flow into the resolver 810 for use with many of the simpler feedback types.

In some embodiments, the set of predefined rules of the resolver 810 limits the number of retries to keep the game flowing in a reasonable and even pleasant way. On a “retry” turn, it also pays particular attention to whether the problem reported in the prior turn has been resolved (with sufficient confidence). If so, it will give the user a positive confirmation, even if a new and different problem was detected.

The set of pre-defined rules of the resolver 810 embodies some of the rules gleaned from conversations with the CV teachers, and from skilled teaching experiences. For example, in some embodiments, the resolver 810 prioritizes SPQ issues first, followed by APM, vowels, stress, then less potentially less critical error types involving syllables and consonants.

In some embodiments, the resolver 810 is enabled to provide feedback only when it can be done with sufficient confidence. However, for game flow and pedagogical reasons, it is not desirable to provide feedback to a user on each and every turn, even if we have some confidence that we've detected an error. In some embodiments, false positives are treated as if they create a worse experience for the user than false negatives, so the resolver 810 adjusts its confidence thresholds to take that into account.

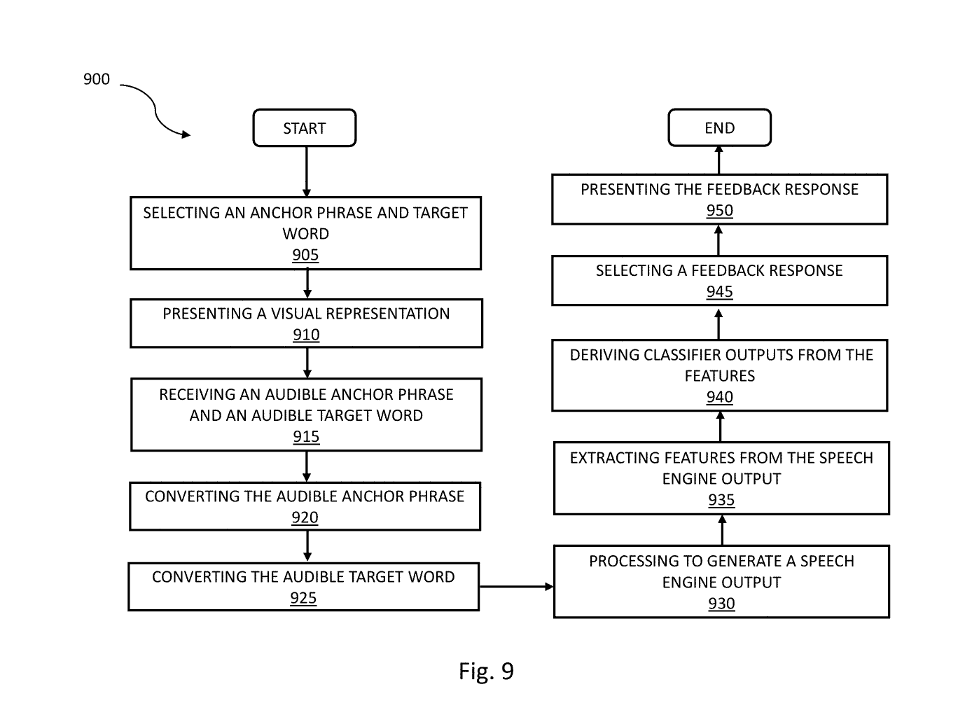

In FIG. 9, is a flowchart of an example computer-implemented method 900 for automatically integrating a machine learning component to improve a spoken language skill of a speaker capable of implementing one or more of the embodiments disclosed herein. In step 905, in some embodiments, the method 900 is selecting an anchor phrase and a target word as part of an interactive game, e.g., the CV game, wherein the anchor phrase has a plurality of words, wherein the anchor phrase and the target word both have an expected vowel sound of a stressed syllable in common, wherein the expected vowel sound is part of an expected phoneme. In step 910, in some embodiments, the method 900 is presenting a visual representation the anchor phrase and the target word to the speaker as part of the interactive game. In step 915, in some embodiments, the method 900 is receiving an audible anchor phrase and an audible target word from the speaker. In step 920, in some embodiments, the method 900 is converting the audible anchor phrase into a digital anchor phrase. In step 925, in some embodiments, the method 900 is converting the audible target word into a digital target word. In step 930, in some embodiments, the method 900 is processing the digital anchor phrase and digital target word with a speech engine to generate a speech engine output, wherein the speech engine output includes a phoneme transcript having at least one candidate phoneme for an expected phoneme from the digital anchor phrase and the digital target word, and an expected phoneme probability for the at least one candidate phoneme, with the speech engine. In step 935, in some embodiments, the method 900 is extracting features from a speech engine output with a feature extraction device and transmitting the features to a plurality of classifiers. In step 940, in some embodiments, the method 900 is deriving classifier outputs from the features with the feedback classifiers and transmitting classifier outputs to a resolver, wherein at least one of the classifiers has a machine learning component. In step 945, in some embodiments, the method 900 is selecting a feedback response with the resolver using a set of pre-defined rules based at least in part on the stressed vowel estimates and phoneme transcript. In step 950, in some embodiments, the method 900 is presenting the feedback response to the speaker.

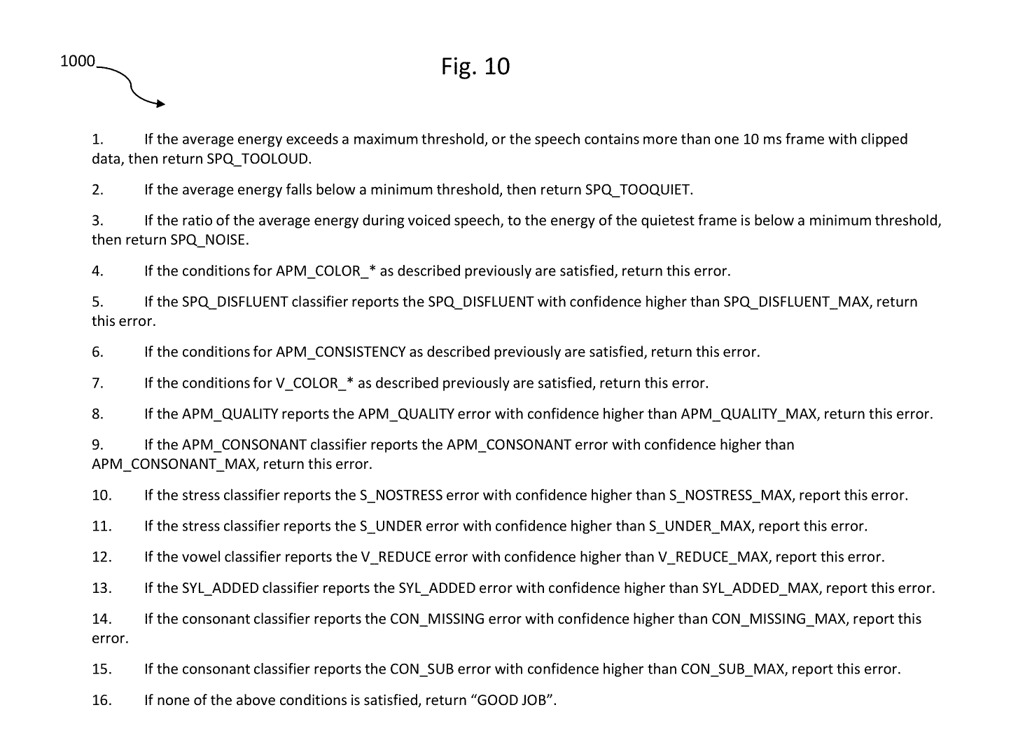

In FIG. 10, is a first table of pseudo-code 1000 of an example computer-implemented method for automatically integrating a machine learning component to improve a spoken language skill of a speaker capable of implementing one or more of the embodiments disclosed herein. In some embodiments a resolver, such as the resolver 810 described with regard to FIG. 8, includes a processor for executing instructions such as the sixteen (16) pseudo-code instructions in FIG. 10 that follow herein: 1. If the average energy exceeds a maximum threshold, or the received and digitized speaker pronunciation (speech) contains more than one 10 millisecond (ms) frame with clipped data, then return SPQ_TOOLOUD. SPQ_TOOLOUD represents a sound and play quality (SPQ) too loud error indicator. 2. If the average speech energy falls below a minimum threshold, then return SPQ_TOOQUIET. SPQ_TOOLOUD represents a sound and play quality (SPQ) too quiet error indicator. 3. If the ratio of the average energy during voiced speech, to the energy of the quietest frame is below a minimum threshold, then return SPQ_NOISE. SPQ_NOISE represents a sound and play quality (SPQ) noise ratio indicator. 4. If the conditions for APM_COLOR_* as described previously are satisfied, return this error. APM_COLOR_* represents an anchor phrase mastery (APM) Color error indicator. APM_COLOR_* indicates that for the stressed vowels of the anchor phrases, the user was consistently wrong in their pronunciation of the vowel sound. This is determined by looking at the top candidate for each stressed vowel as reported by the speech engine. In some embodiments, this represents fourteen (14) different errors, where the asterisk is replaced by the name of the vowel sound that the user produced (as opposed to the correct one). 5. If the SPQ_DISFLUENT classifier reports the SPQ DISFLUENT with confidence higher than SPQ_DISFLUENT_MAX, then return this as an error. The SPQ DISFLUENT classifier represents a sound and play quality (SPQ) disfluency indicator. The SPQ_DISFLUENT_MAX variable represents a sound and play quality (SPQ) disfluency maximum limit variable. 6. If the conditions for APM_CONSISTENCY are satisfied, return this error. APM_CONSISTENCY indicates that for the stressed vowels of the anchor phrases, no consistency was observed. This is determined by looking at the top candidate for each stressed vowel as reported by the speech engine.

7. If the conditions for V_COLOR_* as described previously are satisfied, return this error. The V_COLOR_* variable represents vowel color type. V_COLOR_*indicates that the stressed vowel of the target word was incorrect. This is determined by looking at the top candidate for the target word's stressed vowel, as reported by the speech engine. This bullet item represents 14 different errors, where the asterisk is replaced by the name of the vowel sound that the user produced (as opposed to the correct one).

8. If the APM_QUALITY reports the APM_QUALITY error with confidence higher than APM_QUALITY_MAX, return this error. The APM_QUALITY variable represents an anchor phrase mastery (APM) quality variable. APM_QUALITY is another kind of error indicator. Anchor Phrase Mastery (APM) is a feedback category is concerned with the user's ability to speak the CV anchor phrase correctly. APM Quality corresponds to the stressed vowel sound (in the anchor phrase) that is near the intended vowel sound, but the vowel quality is poor. APM Consonant corresponds to problems with consonants in the anchor phrase. 9. If the APM_CONSONANT classifier reports the APM_CONSONANT error with confidence higher than APM_CONSONANT_MAX, return this error. The APM_CONSONANT classifier represents an anchor phrase mastery (APM) consonant identifier error indicator. 10. If the stress classifier reports the S_NOSTRESS error with confidence higher than S_NOSTRESS_MAX, report this error. The S_NOSTRESS error represents a lack of detected vowel stress as compared to the S_NOSTRESS_MAX error indicator. 11. If the stress classifier reports the S_UNDER error with confidence higher than S_UNDER_MAX, report this error. The S_UNDER error indicator represents an insufficient amount of vowel stress as compared to the S_NOSTRESS_MAX variable. 12. If the vowel classifier reports the V_REDUCE error with confidence higher than V_REDUCE_MAX, report this error. The V_REDUCE error indicator represents an insufficient duration of vowel stress as compared to the V_REDUCE_MAX variable. 13. If the SYL_ADDED classifier reports the SYL_ADDED error with confidence higher than SYL_ADDED_MAX, report this error. The SYL_ADDED classifier represents a syllable added to the expected word error indicator with a confidence higher a maximum SYL_ADDED_MAX variable. 14. If the consonant classifier reports the CON_MISSING error with confidence higher than CON_MISSING_MAX, report this error. The CON_MISSING error indicator represents a missing consonant missing from the expected word with a confidence higher a maximum SYL_ADDED_MAX variable. 15. If the consonant classifier reports the CON_SUB error with confidence higher than CON_SUB_MAX, report this error. The CON_SUB error indicator represents a consonant missing from the expected word with a confidence higher a maximum CON_SUB_MAX variable. 16. If none of the above conditions is satisfied, return “GOOD JOB” and present to the speaker.

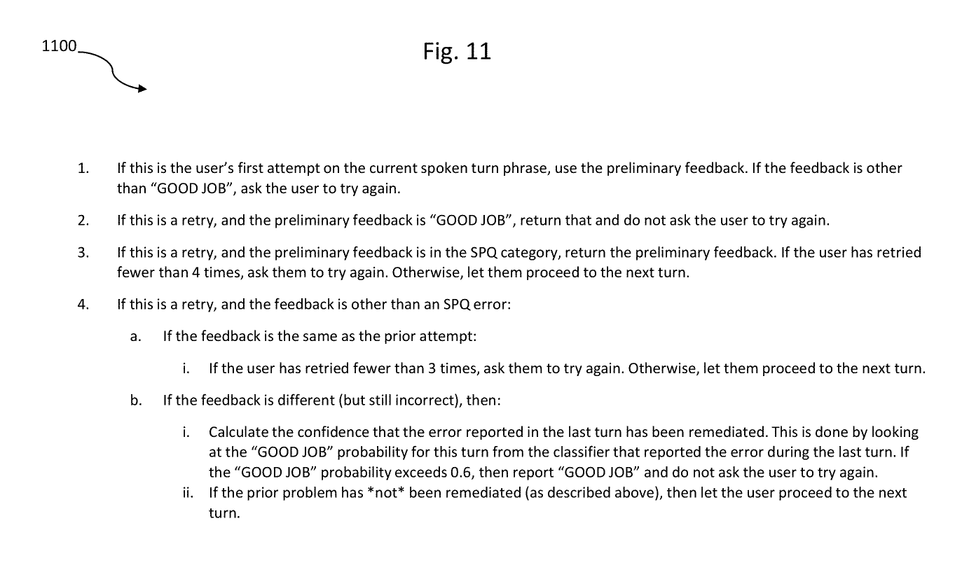

In FIG. 11, is a second table of pseudo-code 1100 of an example computer-implemented method for automatically integrating a machine learning component to improve a spoken language skill of a speaker capable of implementing one or more of the embodiments disclosed herein. In some embodiments a resolver, such as the resolver 810 described with regard to FIG. 8, includes a processor for executing instructions such as the four (4) pseudo-code instructions in FIG. 11 the follow herein: 1. If this is the user's (speaker's) first attempt on the current spoken turn phrase, use the preliminary feedback. If the feedback is other than “GOOD JOB”, ask the user to try again. 2. If this is a retry, and the preliminary feedback is “GOOD JOB”, return that and do not ask the user to try again. 3. If this is a retry, and the preliminary feedback is in the SPQ category, return the preliminary feedback. If the user has retried fewer than four (4) times, ask them to try again. Otherwise, let them proceed to the next turn. 4. If this is a retry, and the feedback is other than an SPQ error: If the feedback is the same as the prior attempt: If the user has retried fewer than 3 times, ask them to try again. Otherwise, let them proceed to the next turn. If the feedback is different (but still incorrect), then: calculate the confidence that the error reported in the last turn has been remediated. This is done by looking at the “GOOD JOB” probability for this turn from the classifier that reported the error during the last turn. In some embodiments, if the “GOOD JOB” probability exceeds 0.6, then report “GOOD JOB” and do not ask the user to try again. If the prior problem has *not* been remediated (as described above), then let the user proceed to the next turn.

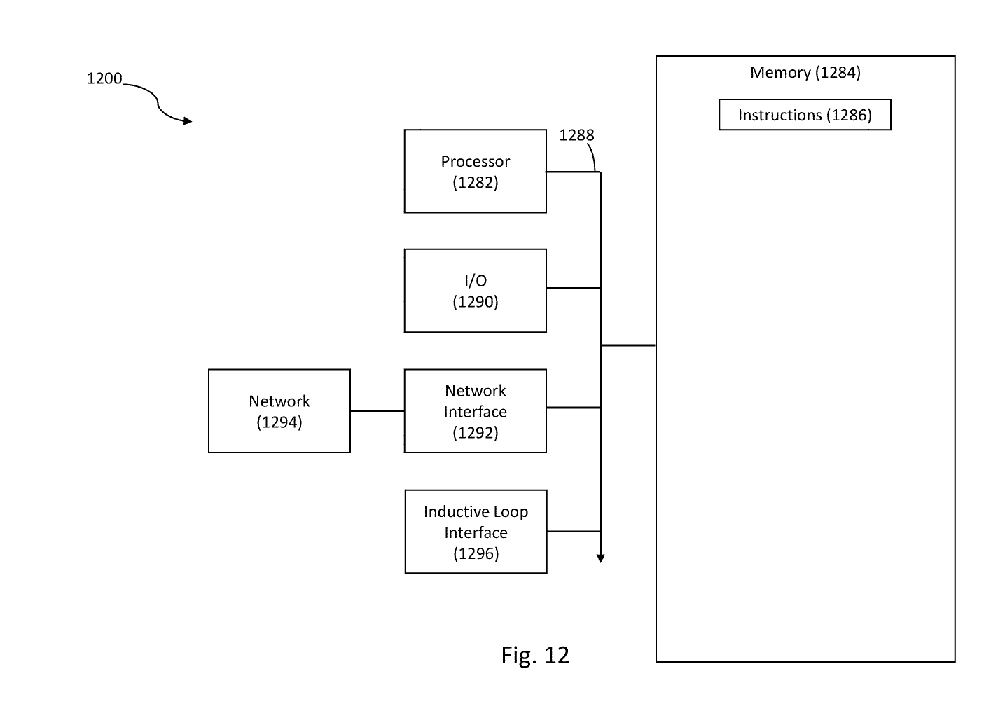

In FIG. 12, is a block diagram of an example computer-implemented method for automatically integrating a machine learning component to improve a spoken language skill of a speaker capable of implementing one or more of the embodiments disclosed herein.

Referring to FIG. 12, a block diagram of a computer system 1200 portion of an example user interface of a computer-implemented method for automatically integrating a machine learning component to improve a spoken language skill of a speaker capable of implementing one or more of the embodiments disclosed herein, according to the present disclosure, is shown.

In some embodiments, the computer system 1200 is part of the user's communications device 105 (FIG. 1). In other embodiments, the computer system 1200 is part of a speech processing engine 810 (FIG. 8). In still other embodiments, the computer system produces the lexicon 830 (FIG. 8), transcript 840 (FIG. 8) and audio 850 (FIG. 8). In the computer implemented method of FIGS. 1-11, (FIG. 1). In still other embodiments, the computer system 1200 is part of the resolver 810 (FIG. 8). In even other embodiments the computer system 1200 is part of the mobile device 205 (FIG. 2), mobile device 305 (FIG. 3), mobile device 405 (FIG. 4), mobile device 505 (FIG. 5), mobile device 605 (FIG. 6) and any other computing device capable of executing instructions illustrated in the figures.

Computer system 1200 includes a hardware processor 1282 and a non-transitory, computer readable storage medium 1284 encoded with, i.e., storing, the computer program code 1286, i.e., a set of executable instructions. The processor 1282 is electrically coupled to the computer readable storage medium 1284 via a bus 1288. The processor 1282 is also electrically coupled to an I/O interface 1290 by bus 1288. A network interface 1292 is also electrically connected to the processor 902 via bus 1288. Network interface 1292 is connected to a network 1294, so that processor 1282 and computer readable storage medium 1284 are capable of connecting and communicating to external elements via network 1294. An inductive loop interface 1296 is also electrically connected to the processor 1282 via bus 1288. Inductive loop interface 1296 provides a diverse communication path from the network interface 1292.

In some embodiments, inductive loop interface 1296 or network interface 1292 are replaced with a different communication path such, as optical communication, microwave communication, or other suitable communication paths. The processor 1282 is configured to execute the computer program code 1286 encoded in the computer readable storage medium 1284 in order to cause computer system 1200 to be usable for performing a portion or all of the operations as described with respect to the data communications network.

In some embodiments, the processor 1282 is a central processing unit (CPU), a multi-processor, a distributed processing system, an application specific integrated circuit (ASIC), and/or a suitable processing unit.

In some embodiments, the computer readable storage medium 1284 is an electronic, magnetic, optical, electromagnetic, infrared, and/or a semiconductor system (or apparatus or device). For example, the computer readable storage medium 1284 includes a semiconductor or solid-state memory, a magnetic tape, a removable computer diskette, a random access memory (RAM), a read-only memory (ROM), a rigid magnetic disk, and/or an optical disk. In some embodiments using optical disks, the computer readable storage medium 1284 includes a compact disk-read only memory (CD-ROM), a compact disk-read/write (CD-R/W), a digital video disc (DVD) and/or Blu-Ray Disk.

In some embodiments, the storage medium 1284 stores the computer program code 1286 configured to cause computer system 1200 to perform the operations as described with respect to the data communications network.

In some embodiments, the storage medium 1284 stores instructions 1286 for interfacing with external components. The instructions 1286 enable processor 1282 to generate operating instructions readable by the data communications network.

Computer system 1200 includes I/O interface 1290. I/O interface 1290 is coupled to external circuitry. In some embodiments, I/O interface 1290 includes a keyboard, keypad, mouse, trackball, trackpad, and/or cursor direction keys for communicating information and commands to processor 1282.

Computer system 1200 also includes network interface 1292 coupled to the processor 1282. Network interface 1292 allows computer system 1200 to communicate with network 1294, to which one or more other computer systems are connected. Network interface 1292 includes wireless network interfaces such as BLUETOOTH, WIFI, WIMAX, GPRS, or WCDMA; or wired network interface such as ETHERNET, USB, or IEEE-1394.

Computer system 1200 also includes inductive loop interface 1296 coupled to the processor 1282. Inductive loop interface 1296 allows computer system 1200 to communicate with external devices, to which one or more other computer systems are connected. In some embodiments, the operations as described above are implemented in two or more computer systems 1200.

Computer system 1200 is configured to receive information related to the instructions 1286 through I/O interface 1290. The information is transferred to processor 1282 via bus 1288 to determine corresponding adjustments to the transportation operation. The instructions are then stored in computer readable medium 1284 as instructions 1286.

In some embodiments, systems and methods described herein employ the Color Vowel® system incorporated into an interactive game that presents an anchor phrase and a target word to a speaker for pronunciation. Correspondingly, a speech engine receives and processes a digitized audible anchor phrase and a digitized target word received from the speaker and produces speech engine output from which a plurality of features are extracted, and a plurality of classifier outputs are then derived from the plurality of features. In some embodiments at least one of a plurality of classifiers that derived the plurality of classifier outputs use a machine learning component. A resolver automatically selects a feedback response using a set of pre-defined rules based at least in part on the plurality of classifier outputs and then presents the feedback response to the speaker to improve their pronunciation skills. In some embodiments, the resolver selects the feedback response based at least in part on the plurality of classifier outputs and further based at least in part on at least one of a record of previous instances of presenting the visual representation the anchor phrase and the target word to the speaker, at least one candidate phoneme and the expected phoneme probability, a vowel stress estimate, a phoneme transcript, assessing a temporal placement of audible vowel stress and quality of audible vowel stress of the at least one candidate phoneme for the expected phoneme from the digital anchor phrase and the digital target word.

Some embodiments described herein include a computer-implemented method for automatically integrating a machine learning component to improve a spoken language skill of a speaker. The method includes selecting an anchor phrase and a target word as part of an interactive game, wherein the anchor phrase has a plurality of words, wherein the anchor phrase and the target word both have an expected vowel sound of a stressed syllable in common, and wherein the expected vowel sound is part of an expected phoneme, presenting a visual representation of the anchor phrase and the target word to the speaker as part of the interactive game, receiving an audible anchor phrase and an audible target word from the speaker, converting the audible anchor phrase into a digital anchor phrase, converting the audible target word into a digital target word, processing the digital anchor phrase and digital target word with a speech engine to generate a speech engine output, wherein the speech engine output includes a phoneme transcript, and wherein the phoneme transcript includes the expected phoneme, extracting a plurality of features from the speech engine output with a feature extraction device and transmitting the plurality of features to a plurality of feedback classifiers, deriving a plurality of classifier outputs from the plurality of features with the feedback classifiers and transmitting the plurality of classifier outputs to a resolver, wherein at least one of the plurality of classifiers use the machine learning component, selecting a feedback response with the resolver using a set of pre-defined rules based at least in part on the plurality of classifier outputs, and presenting the feedback response to the speaker.

Some embodiments described herein include a system for automatically integrating a machine learning component to improve a spoken language skill of a speaker. The system includes at least one physical processor and a physical memory comprising computer-executable instructions that, when executed by the at least one physical processor, cause the at least one physical processor to select an anchor phrase and target word as part of an interactive game, wherein the anchor phrase has a plurality of words, wherein the anchor phrase and the target word both have an expected vowel sound of a stressed syllable in common, and wherein the expected vowel sound is part of an expected phoneme, present a visual representation the anchor phrase and the target word to the speaker as part of the interactive game, receive an audible anchor phrase and an audible target word from the speaker, convert the audible anchor phrase into a digital anchor phrase, convert the audible target word into a digital target word, process the digital anchor phrase and digital target word with a speech engine to generate a speech engine output, wherein the speech engine output includes a phoneme transcript, and wherein the phoneme transcript includes the expected phoneme, extract a plurality of features from the speech engine output with a feature extraction device and transmitting the plurality of features to a plurality of feedback classifiers, derive a plurality of classifier outputs from the plurality of features with the feedback classifiers and transmitting the plurality of classifier outputs to a resolver, wherein at least one of the plurality of classifiers use the machine learning component, select a feedback response with the resolver using a set of pre-defined rules based at least in part on the plurality of classifier outputs, and present the feedback response to the speaker.

Some embodiments described herein include a non-transitory computer-readable medium. The non-transitory computer-readable medium includes one or more computer-executable instructions that, when executed by at least one processor of a computing device, cause the computing device to select an anchor phrase and target word as part of an interactive game, wherein the anchor phrase has a plurality of words, wherein the anchor phrase and the target word both have an expected vowel sound of a stressed syllable in common, and wherein the expected vowel sound is part of an expected phoneme, present a visual representation the anchor phrase and the target word to the speaker as part of the interactive game, receive an audible anchor phrase and an audible target word from the speaker, convert the audible anchor phrase into a digital anchor phrase, convert the audible target word into a digital target word, process the digital anchor phrase and digital target word with a speech engine to generate a speech engine output, wherein the speech engine output includes a phoneme transcript, and wherein the phoneme transcript includes the expected phoneme, extract a plurality of features from the speech engine output with a feature extraction device and transmitting the plurality of features to a plurality of feedback classifiers, derive a plurality of classifier outputs from the plurality of features with the feedback classifiers and transmitting the plurality of classifier outputs to a resolver, wherein at least one of the plurality of classifiers use the machine learning component, select a feedback response with the resolver using a set of pre-defined rules based at least in part on the plurality of classifier outputs, and present the feedback response to the speaker.

It will be understood that various modifications can be made to the embodiments of the present disclosure herein without departing from the scope thereof. Therefore, the above description should not be construed as limiting the disclosure, but merely as disclosing embodiments thereof. Those skilled in the art will envision other modifications within the scope of the invention as defined by the claims appended hereto.

What is claimed is:

1. A computer-implemented method for automatically integrating a machine learning component to improve a spoken language skill of a speaker, comprising:
selecting an anchor phrase and a target word as part of an interactive game, wherein the anchor phrase has a plurality of words, wherein the anchor phrase and the target word both have an expected vowel sound of a stressed syllable in common, and wherein the expected vowel sound is part of an expected phoneme;
presenting a visual representation of the anchor phrase and the target word to the speaker as part of the interactive game;
receiving an audible anchor phrase and an audible target word from the speaker;
converting the audible anchor phrase into a digital anchor phrase;
converting the audible target word into a digital target word;
processing the digital anchor phrase and digital target word with a speech engine to generate a speech engine output, wherein the speech engine output includes a phoneme transcript, and wherein the phoneme transcript includes the expected phoneme;
extracting a plurality of features from the speech engine output with a feature extraction device and transmitting the plurality of features to a plurality of feedback classifiers;
deriving a plurality of classifier outputs from the plurality of features with the feedback classifiers and transmitting the plurality of classifier outputs to a resolver, wherein at least one of the plurality of classifiers use the machine learning component;
selecting a feedback response with the resolver using a set of pre-defined rules based at least in part on the plurality of classifier outputs; and
presenting the feedback response to the speaker.

2. The computer-implemented method of claim 1, wherein the selecting the feedback response with the resolver based at least in part on the plurality of classifier outputs is further based at least in part on a record of previous instances of presenting the visual representation the anchor phrase and the target word to the speaker.

3. The computer-implemented method of claim 1, wherein the phoneme transcript includes at least one candidate phoneme for the expected phoneme from the digital anchor phrase and the digital target word, and an expected phoneme probability for the at least one candidate phoneme, wherein the selecting the feedback response with the resolver based at least in part on the plurality of classifier outputs is further based at least in part on the at least one candidate phoneme and the expected phoneme probability.

4. The computer-implemented method of claim 1, wherein the phoneme transcript includes a vowel stress estimate for at least one candidate phoneme for the expected phoneme from the digital anchor phrase and the digital target word, wherein the selecting the feedback response with the resolver based at least in part on the plurality of classifier outputs is further based at least in part on the vowel stress estimate.

5. The computer-implemented method of claim 1, wherein the resolver directly receives the phoneme transcript, and wherein the selecting the feedback response with the resolver based at least in part on the plurality of classifier outputs is further based at least in part on the phoneme transcript received by the resolver.

6. The computer-implemented method of claim 4, wherein the vowel stress estimate includes assessing a temporal placement of audible vowel stress and quality of audible vowel stress of the at least one candidate phoneme for the expected phoneme from the digital anchor phrase and the digital target word.

7. The computer-implemented method of claim 1, wherein the anchor phrase is selected from a pronunciation notation system.

8. The computer-implemented method of claim 1, wherein the anchor phrase is selected from Color Vowel®.

9. The computer-implemented method of claim 1, further comprising:
detecting, with the machine learning component, at least one of a phoneme insertion, a phoneme deletion and a phoneme substitution.

10. A system for automatically integrating a machine learning component to improve a spoken language skill of a speaker, the system comprising:
at least one physical processor; and
a physical memory comprising computer-executable instructions that, when executed by the at least one physical processor, cause the at least one physical processor to:
select an anchor phrase and target word as part of an interactive game, wherein the anchor phrase has a plurality of words, wherein the anchor phrase and the target word both have an expected vowel sound of a stressed syllable in common, and wherein the expected vowel sound is part of an expected phoneme;
present a visual representation the anchor phrase and the target word to the speaker as part of the interactive game;
receive an audible anchor phrase and an audible target word from the speaker;
convert the audible anchor phrase into a digital anchor phrase;
convert the audible target word into a digital target word;
process the digital anchor phrase and digital target word with a speech engine to generate a speech engine output, wherein the speech engine output includes a phoneme transcript, and wherein the phoneme transcript includes the expected phoneme;
extract a plurality of features from the speech engine output with a feature extraction device and transmitting the plurality of features to a plurality of feedback classifiers;
derive a plurality of classifier outputs from the plurality of features with the feedback classifiers and transmitting the plurality of classifier outputs to a resolver, wherein at least one of the plurality of classifiers use the machine learning component;
select a feedback response with the resolver using a set of pre-defined rules based at least in part on the plurality of classifier outputs; and
present the feedback response to the speaker.

11. The system of claim 10, wherein the computer-executable instructions causing the system to select a feedback response with a resolver based at least in part on the plurality of classifier outputs is further based at least in part on a record of previous instances of presenting the visual representation the anchor phrase and the target word to the speaker.

12. The system of claim 11, wherein the phoneme transcript includes at least one candidate phoneme for the expected phoneme from the digital anchor phrase and the digital target word, and an expected phoneme probability for the at least one candidate phoneme, wherein the computer-executable instructions causing the system to select the feedback response with the resolver based at least in part on the plurality of classifier outputs is further based at least in part on the at least one candidate phoneme and the expected phoneme probability.

13. The system of claim 11, wherein the phoneme transcript includes a vowel stress estimate for at least one candidate phoneme for the expected phoneme from the digital anchor phrase and the digital target word, wherein the computer-executable instructions causing the system to select the feedback response with the resolver based at least in part on the plurality of classifier outputs is further based at least in part on vowel stress estimate.

14. The system of claim 11, wherein the resolver directly receives the phoneme transcript, and wherein the computer-executable instructions causing the system to select the feedback response with the resolver based at least in part on the plurality of classifier outputs is further based at least in part on the phoneme transcript received by the resolver.

15. The system of claim 11, wherein the vowel stress estimate includes assessing a temporal placement of audible vowel stress and quality of audible vowel stress of the at least one candidate phoneme for the expected phoneme from the digital anchor phrase and the digital target word.

16. The system of claim 11, wherein the anchor phrase is selected from a pronunciation notation system.

17. A non-transitory computer-readable medium comprising one or more computer-executable instructions that, when executed by at least one processor of a computing device, cause the computing device to:
select an anchor phrase and target word as part of an interactive game, wherein the anchor phrase has a plurality of words, wherein the anchor phrase and the target word both have an expected vowel sound of a stressed syllable in common, and wherein the expected vowel sound is part of an expected phoneme;
present a visual representation the anchor phrase and the target word to the speaker as part of the interactive game;
receive an audible anchor phrase and an audible target word from the speaker;
convert the audible anchor phrase into a digital anchor phrase;
convert the audible target word into a digital target word;
process the digital anchor phrase and digital target word with a speech engine to generate a speech engine output, wherein the speech engine output includes a phoneme transcript, and wherein the phoneme transcript includes the expected phoneme;
extract a plurality of features from the speech engine output with a feature extraction device and transmitting the plurality of features to a plurality of feedback classifiers;
derive a plurality of classifier outputs from the plurality of features with the feedback classifiers and transmitting the plurality of classifier outputs to a resolver, wherein at least one of the plurality of classifiers use the machine learning component;
select a feedback response with the resolver using a set of pre-defined rules based at least in part on the plurality of classifier outputs; and
present the feedback response to the speaker.

18. The non-transitory computer-readable medium of claim 17, wherein the computer-executable instructions causing the system to select a feedback response with a resolver based at least in part on the plurality of classifier outputs is further based at least in part on a record of previous instances of presenting the visual representation the anchor phrase and the target word to the speaker.

19. The non-transitory computer-readable medium of claim 17, wherein the phoneme transcript includes at least one candidate phoneme for the expected phoneme from the digital anchor phrase and the digital target word, and an expected phoneme probability for the at least one candidate phoneme, wherein the computer-executable instructions causing the system to select the feedback response with the resolver based at least in part on the plurality of classifier outputs is further based at least in part on the at least one candidate phoneme and the expected phoneme probability.

20. The non-transitory computer-readable medium of claim 17, wherein the phoneme transcript includes a vowel stress estimate for at least one candidate phoneme for the expected phoneme from the digital anchor phrase and the digital target word, wherein the computer-executable instructions causing the system to select the feedback response with the resolver based at least in part on the plurality of classifier outputs is further based at least in part on vowel stress estimate.
